(19) United States
(12) Patent Application Publication
(10) Pub. No.: US 2008/0092973 A1
(43) Pub. Date: Apr. 24, 2008

(54) Flexible heat pipe

(75) Inventor: Yaw-Huey Lai, Taipei County (TW)

Correspondence Address: BACON & THOMAS, PLLC, 625 SLATERS LANE, FOURTH FLOOR, ALEXANDRIA, VA, 22314, US

(73) Assignee: TAI-SOL ELECTRONICS CO., LTD., TAIPEI CITY (TW)

(21) Appl. No.: 11/649,909

(22) Filed: Jan. 5, 2007

(30) Foreign Application Priority Data
Oct. 20, 2006 (TW) 95218637

(51) Int. Cl. F16L 11/00

(52) U.S. Cl. 138/118

(57) ABSTRACT

A flexible pipe includes a tubular member and a capillary material. The tubular member includes two closed ends and defines a flexible section having a sidewall of wavelike embossment. The capillary material is mounted to an inner side of the tubular member. Accordingly, the wavelike embossment of the flexible section facilitates the bending of the pipe to allow the user to bend the pipe directly by hands thereof without over-bending or depression of the pipe.

### BACKGROUND OF THE INVENTION

1. Field of the Invention

The present invention relates generally to the heat-dissipating technology, and more particularly, to a flexible heat pipe.

2. Description of the Related Art

A conventional heat pipe is usually straight in shape, while made and formed, and then bent at required radian to accommodate various targets of installation. However, while doing the operation of bending the heat pipe, it is required to utilize the jig and implement to accomplish the operation. If the operation is done by a user's hands, it may cause over-bending or depression of the heat pipe and further damage the heat pipe. Further, it is difficult to control the bending degree through the manual bending operation.

Alternatively, while the heat pipe is made, the heat pipe can be bent beforehand until the required shape is formed and then the capillary material and water can be mounted inside the heat pipe. It is not required to bend such heat pipe after it is made. However, if there is any tolerance occurred while such heat pipe bent beforehand is formed, it will be difficult for installation and adjustment in practical application; otherwise, it also has to utilize the jig or implement for the adjustment to incur trouble in installation.

### SUMMARY OF THE INVENTION

The primary objective of the present invention is to provide a flexible pipe, which can be directly bent manually without over-bending or depression thereof.

The secondary objective of the present invention is to provide a flexible pipe, which can be randomly and directly bent to facilitate adjustment of the tolerance while installed and allow bending thereof as per the user's desired radian of the bending.

The foregoing objectives of the present invention are attained by the flexible pipe composed of a tubular member and a capillary material. The tubular member includes two closed ends and defines a flexible section having a sidewall of wavelike embossment. The capillary material is mounted to an inner side of the tubular member. Accordingly, the wavelike embossment of the flexible section facilitates the bending of the pipe to allow the user to bend the pipe directly by hands thereof without over-bending or depression of the pipe.

### BRIEF DESCRIPTION OF THE DRAWINGS

FIG. 1 is a perspective view of a first preferred embodiment of the present invention.

FIG. 2 is a side view of the first preferred embodiment of the present invention.

FIG. 3 is a sectional view taken along a line 3-3 indicated in FIG. 2.

FIG. 4 is a partial enlarged view of FIG. 3.

FIG. 5 is a sectional view of a second preferred embodiment of the present invention.

FIG. 6 is a partial enlarged view of FIG. 5.

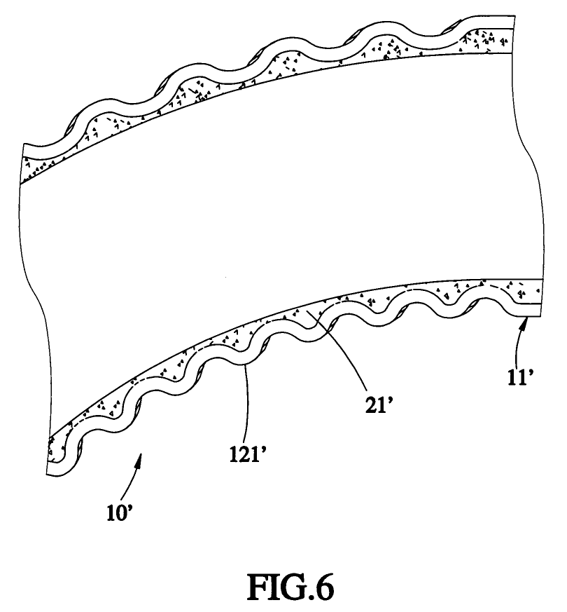

### DETAILED DESCRIPTION OF PREFERRED EMBODIMENTS

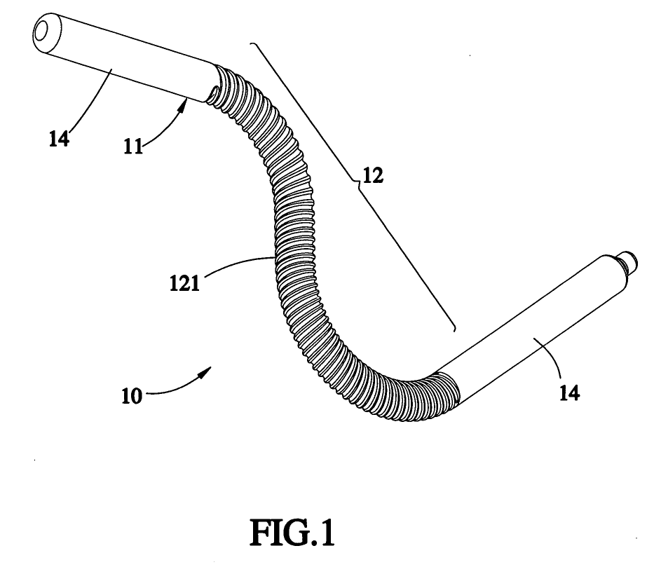

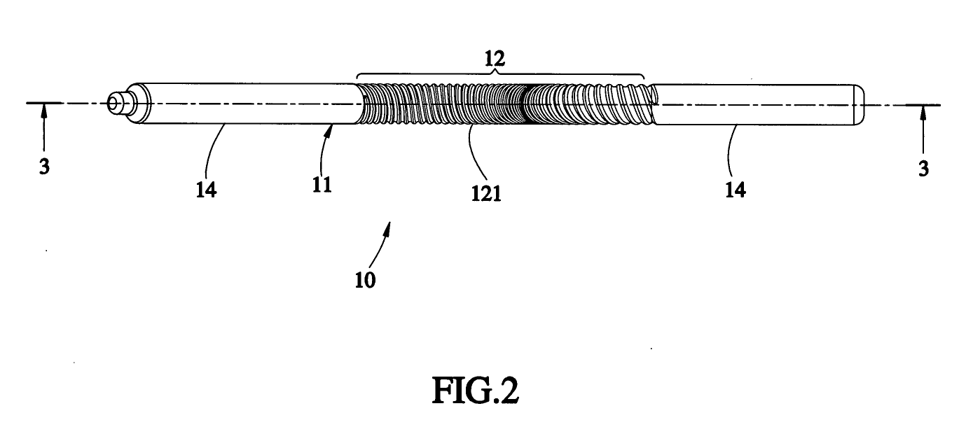

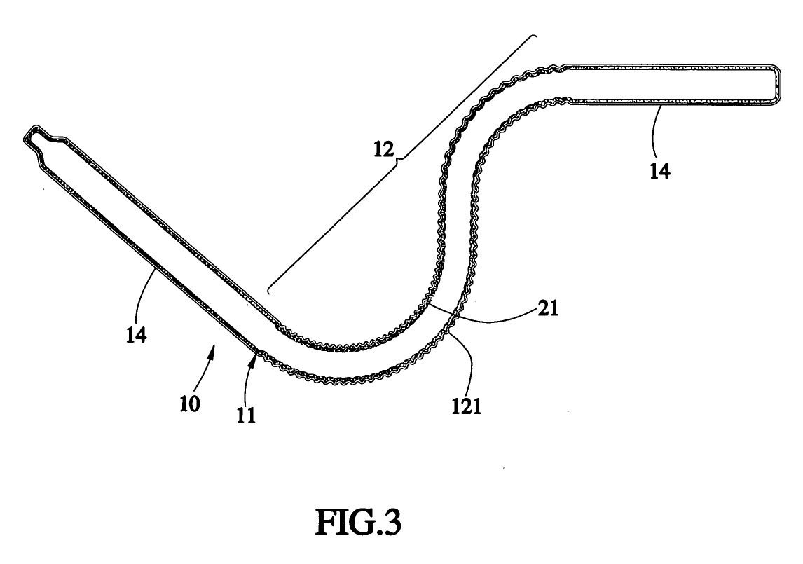

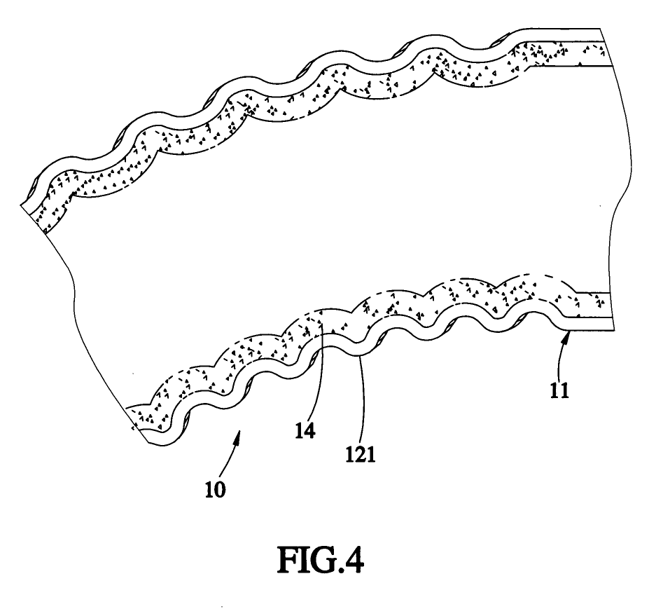

Referring to FIGS. 1-4, a flexible pipe 10 constructed according to a first preferred embodiment of the present invention is composed of a tubular member 11 and a capillary material 21.

The tubular member 11 includes two closed ends and defines a flexible section 12 having a predetermined length and located at a midsection of the tubular member 11, a straight section 14 located at two ends of the tubular member 11 respectively, and a sidewall having a wavelike embossment 121 and spirally formed on the tubular member 11.

The capillary material 21 can be a metallic mesh or made of sintered copper powder. In this embodiment, the capillary material 21 is made of sintered cooper powder. Since the capillary material 21 of the metallic mesh belongs to prior art, no detailed description is necessary. The capillary material 21 is mounted to an inner side of the tubular member 11 to be tubular, having a sidewall being wavelike in corresponding shape to the sidewall of the flexible section 12 because the capillary material 21 is sintered in the tubular member 11 before the wavelike embossment 121 of the flexible section 12 is formed.

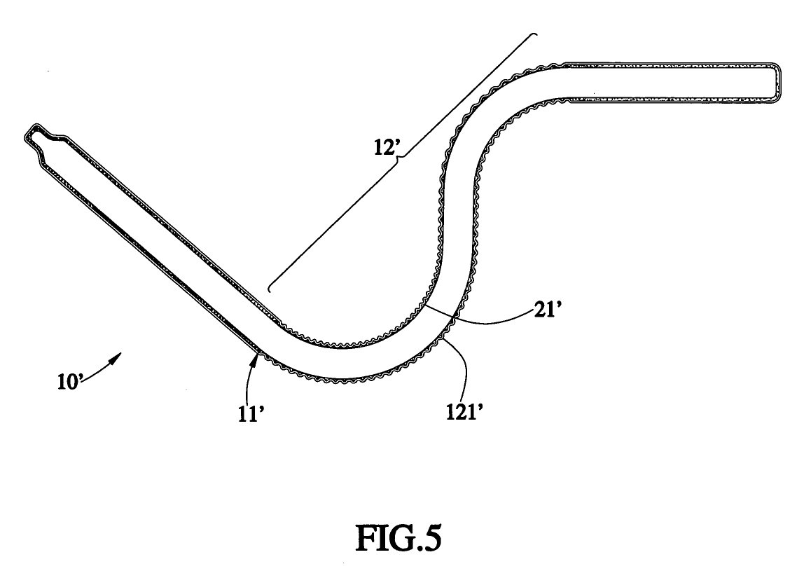

Referring to FIG. 5, a flexible pipe 10′ constructed according to a second preferred embodiment of the present invention is similar to the first embodiment but different in that the sidewall of the capillary material 21 is not wavelike in shape but smooth because the capillary material 21′ is sintered in the tubular member 12′ after the wavelike embossment 121′ of the flexible section 12 is formed.

While either of the heat pipes of the aforementioned embodiments is in use, the user can bend the heat pipe easily through the wavelike embossment of the flexible section and do the bending by the user's hands; further, it is not subject to over-bending or depression of a part of the heat pipe. The straight sections 14 of the tubular member 11 can be mounted to other device in need of heat dissipation. In light of the flexibility of the present invention, the user can bend the heat pipe directly by the hands for installation without using any jig or implement to conveniently adjust the tolerance and the bending can be done easily as per the user's desired position and angle.

Although the present invention has been described with respect to two specific preferred embodiments thereof, it is no way limited to the details of the illustrated structures but changes and modifications may be made within the scope of the appended claims.

What is claimed is:

1. A flexible heat pipe comprising:
a tubular member having two closed ends and defining a flexible section having a predetermined length, said flexible section having a wavelike embossment formed at a sidewall thereof; and
a capillary material mounted to an inner side of said tubular member.

2. The flexible heat pipe as defined in claim 1, wherein said wavelike embossment is spirally formed on said tubular member.

3. The flexible heat pipe as defined in claim 1, wherein said capillary material is tubular and provided with a spiral sidewall in corresponding shape to that of said flexible section.

4. The flexible heat pipe as defined in claim 1, wherein said capillary material is tubular in shape and provided with a smooth inner sidewall.

5. The flexible heat pipe as defined in claim 1, wherein said flexible section is located at a midsection of said tubular member and said tubular member further comprises two straight sections formed at two ends thereof.
